(19) United States
(12) Patent Application Publication
(10) Pub. No.: US 2015/0254779 A1
(43) Pub. Date: Sep. 10, 2015

(54) METHOD OF IDENTIFYING AND FORWARDING PAST MEDICAL CLAIMS PROCESSED BY A FIRST INSURANCE COMPANY TO A DIFFERENT SECOND INSURANCE COMPANY

(71) Applicant: Office Ally, LLC, Vancouver, WA (US)

(72) Inventor: Brian P. O'Neill, Vancouver, WA (US)

(73) Assignee: Office Ally, LLC, Vancouver, WA (US)

(21) Appl. No.: 14/199,098

(22) Filed: Mar. 6, 2014

(51) Int. Cl. G06Q 40/08

(52) U.S. Cl. CPC G06Q 40/08; G06Q 50/22

(57) ABSTRACT

A method that includes storing claim records for patients. Each record stores (a) personal information associated with one of the patients, and (b) claim information received from a claim data provider. The claim information stored in some of the records was submitted to different insurance companies. The claim information stored in some of the records was received from different claim data providers. A member identifier is automatically generated for each of the records as a function of a portion of the personal information stored in the record, and the record is associated with the member identifier. A member identifier is automatically generated as a function of a portion of personal information associated with a particular patient. A record associated with the same member identifier generated for the particular patient is identified and a portion of the claim information stored in the identified record is forwarded to a recipient insurance company.

### BACKGROUND OF THE INVENTION

1. Field of the Invention

The present invention is directed generally to methods of associating medical claims generated by multiple healthcare providers with a particular patient.

2. Description of the Related Art

When a new member signs up for or enrolls in medical insurance coverage for the first time with a medical insurance company, that insurance company knows nothing about the prior medical history of the new member. Thus, until the insurance company receives a claim for services related to a chronic illness, the insurance company is completely unaware that the new member is a chronically ill patient.

If an insurance company is aware that a particular patient has a health issue (such as a chronic illness), the insurance company may take actions to help manage costs related to treating that health issue. For example, the insurance company may implement case management, which may include, for example, evaluating the patient's condition, developing and implementing a care plan, coordinating medical resources, communicating healthcare needs to the patient and/or care givers, monitoring the patient's progress, and the like. Case management may help the patient manage and/or treat the health issue and at the same time, may help the insurance company manage and/or control costs associated with treating the patient.

On the other hand, if the insurance company is unaware of the health issue, the patient may incur medical expenses that could have been avoided. For example, the patient may not adequately manage the health issue, which may result in an expensive trip to an emergency room. Also, the insurance company may order tests that were already performed previously. For example, to increase Healthcare Effectiveness Data and Information Set (“HEDIS”) scores, the insurance company may order unnecessarily and expensive tests (such as a mammogram, a colonoscopy, one or more laboratory tests, and the like) that were performed previously and processed by a previous insurance company.

Therefore, a need exists for methods of informing an insurance company when a new member has existing health problems (such as a chronic illness). A method that informs the insurance company of past claims processed by a previous insurance company would be particularly desirable. The present application provides these and other advantages as will be apparent from the following detailed description and accompanying figures.

### BRIEF DESCRIPTION OF THE SEVERAL VIEWS OF THE DRAWING(S)

FIG. 1 is a block diagram of a system including a computing system operated by a clearinghouse that implements a claim database.

FIG. 2 is an illustration of a method of assigning a clearinghouse generated member identifier (“CG-ID”) to each record in the claim database.

FIG. 3 is an illustration of a method of receiving a new member file from an insurance company, generating a CG-ID for each new member, querying the claim database for any records associated with each CG-ID, and forwarding any records located to the insurance company.

FIG. 4 is a flow diagram of a method performed by the computing system operated by the clearinghouse.

FIG. 5 is a diagram of a hardware environment and an operating environment in which the computing devices of the system of FIG. 1 may be implemented.

Like reference numerals have been used to identify like components in the figures.

### DETAILED DESCRIPTION OF THE INVENTION

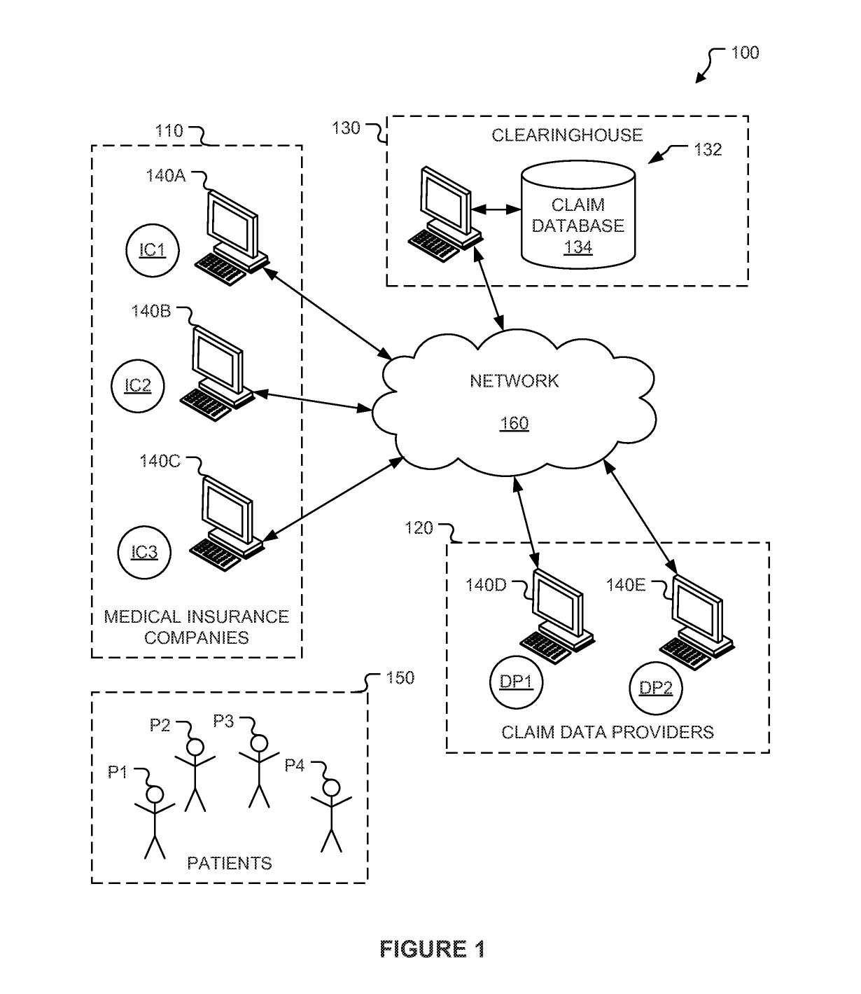

FIG. 1 is a block diagram of a system 100 that includes a plurality of medical insurance companies 110, a plurality of claim data providers 120, and a clearinghouse 130. FIG. 1 also depicts a plurality of patients 150. For ease of illustration, the patients 150 have been illustrated as patients P1-P4. However, as is appreciated by those of ordinary skill in the art, the patients 150 may include any number of patients.

Also for ease of illustration, in FIG. 1, the insurance companies 110 have been illustrated as including insurance companies IC1-IC3 operating computing devices 140A-140C, respectively. However, the insurance companies 110 may include any number of insurance companies, and each insurance company may operate any number of computing devices.

Each of the patients 150 receives medical insurance coverage from one or more of the insurance companies 110. Such insurance coverage may be provided pursuant to a direct contractual relationship between one of the patients 150 and one of the insurance companies 110, an employment arrangement, or through a third party. For example, the patient P3 may contract directly with one of the insurance companies 110 for medical insurance coverage. If the patient P4 is a child of the patient P3, the patient P3 may contract directly with one of the insurance companies 110 for medical insurance coverage for the patient P4 in which case the patient P4 receives insurance coverage via a third party, namely the patient P3. By way of yet another non-limiting example, an employer of the patient P1 may obtain medical insurance coverage from one or more of the insurance companies 110 for the employer's employees, including the patient P1. By way of yet another example, the patient P2 may be the spouse of the patient P1 and may receive medical insurance coverage through the employer of the patient P1.

The claim data providers 120 may include healthcare service providers (e.g., hospitals, laboratories, medical clinics, imaging centers, and the like), vendors of medical products, clearinghouses of claim data, and the like. Clearinghouses do not themselves provide medical and/or healthcare services. Two or more of the claim data providers 120 may be completely unaffiliated with one another. In the embodiment illustrated, the claim data providers 120 include claim data providers DP1 and DP2 operating computing devices 140D and 140E, respectively. However, the claim data providers 120 may include any number of claim data providers, and each claim data provider may operate any number of computing devices. For ease of illustration, the claim data provider DP1 will be described as being a healthcare service provider, and the claim data provider DP2 will be described as being a clearinghouse.

When one of the patients 150 uses medical services provided by the claim data provider DP1, the claim data provider DP1 generates a claim and submits that claim to the patient's insurance company. For example, the patient P1 may receive medical insurance coverage from the insurance company IC1. If the patient P1 receives medical services (e.g., an examination) from the claim data provider DP1, the claim data provider DP1 will generate a claim to be submitted to the insurance company IC1. Instead of submitting the claim directly to the insurance companies 110, some claim data providers (e.g., the claim data provider DP1) submit claims to the clearinghouse 130. The clearinghouse 130 reviews, and if necessary, revises, and/or reformats the claims. Then, the clearinghouse 130 submits the claims to the insurance companies 110. For ease of illustration, the claim data provider DP1 will be described as submitting claims to the clearinghouse 130.

The clearinghouse 130 operates a computing system 132. The computing system 132 includes one or more computing devices, and may be connected by a network 160 (e.g., the Internet) to one or more of the computing devices 140A-140E of the system 100. In the embodiment illustrated, the computing system 132 implements a claim database 134. As mentioned above, the clearinghouse 130 receives claims from one or more of the claim data providers 120, and submits those claims to one or more of the insurance companies 110 for payment. Thus, the clearinghouse 130 receives claim data from those of the claim data providers 120 that use the clearinghouse 130 to submit claims. The clearinghouse 130 stores that claim data in the claim database 134.

Optionally, the clearinghouse 130 may receive claim data from other clearinghouses, such as the claim data provider DP2. When this occurs, the clearinghouse 130 stores that claim data in the claim database 134.

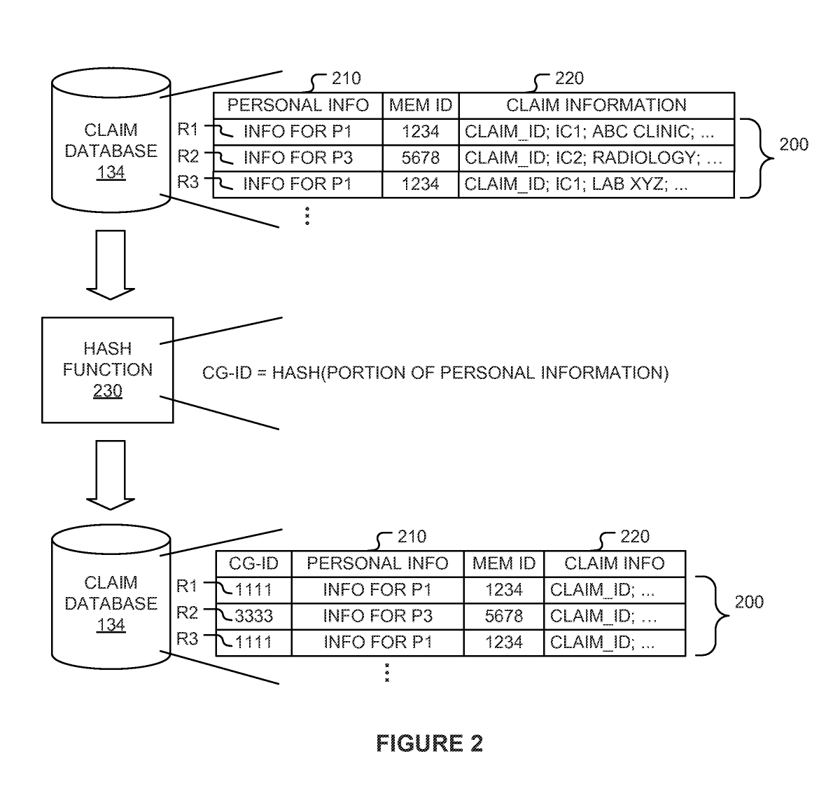

Referring to FIG. 2, the claim database 134 stores a plurality of claim records 200 that each identifies a claim submitted by one of the claim data providers 120 to one or more of the insurance companies 110 for one of the patients 150. Thus, each of the claim records 200 is associated with one of the patients 150, one of the claim data providers 120, and at least one of the insurance companies 110. Further, each of the claim records 200 includes (or is associated with) personal information 210 related to the patient associated with the record, and claim information 220 related to the claim submitted for the patient associated with the record. The claim information 220 identifies which of the claim data providers 120 submitted the claim, and to which of the insurance companies 110 the claim has been submitted.

For example, in FIG. 2, the claim records 200 include claim records R1-R3. The first claim record R1 stores personal information for the patient P1, a member identifier (“1234”) associated with the patient P1, and claim information related to a claim generated by a claim data provider named “ABC Clinic” for submission to the insurance company IC1. The second claim record R2 stores personal information for the patient P3, a member identifier (“5678”) associated with the patient P3, and claim information related to a claim generated by a claim data provider named “Radiology” for submission to the insurance company IC2. The third claim record R3 stores personal information for the patient P1, the member identifier (“1234”) associated with the patient P1, and claim information related to a claim generated by a claim data provider named “Lab XYZ” for submission to the insurance company IC1.

As explained in the Background Section, if an insurance company is aware that a particular patient has a health issue, the insurance company may take actions (such as implementing case management) to help manage costs related to treating that health issue. On the other hand, if the insurance company is unaware of the health issue, the patient may incur medical expenses that could have been avoided. Unawareness of an existing health issue may occur, for example, when an insurance company first begins insuring a new member even if one or more other insurance companies previously insured the same member because the insurance companies 110 do not share information related to members and/or claims with one another. Further, the insurance companies 110 do not assign a single member (or patient) identifier that uniquely identifies each member across all of the insurance companies 110. Thus, before the present teachings, if a patient changed insurance companies, the new insurance company would not have access to, or awareness of, past claims submitted to others of the insurance companies 110 (if any) that previously insured the new member.

For ease of illustration, the patient P1 will be described as being a new member of the insurance company 102, and a former member of the insurance company 101. Also for ease of illustration, the patient P2 will be described as being a new member of the insurance company 102. However, the patient P2 was not a former member of any of the other insurance companies 110. Thus, the new insurance company 102 is unaware of any health issues of the patients P1 and P2 who are new members. However, as mentioned above, the clearinghouse 130 stores, in the claim database 134, claims transmitted to the clearinghouse 130 by the claim data providers 120. Thus, the clearinghouse 130 is aware of at least some of the health issues experienced by at least some of the patients 150. For example, referring to FIG. 2, the claim database 134 operated by the clearinghouse 130 stores the records R1 and R3, which include claims submitted for the patient P1 by the claim data providers named “ABC Clinic” and “Lab XYZ,” respectively.

The computing system 132 is configured to identify claims submitted for a particular patient (e.g. the patient P1) across two or more of the insurance companies 110, and forward those claims to a subsequent (new) insurance company (e.g., the insurance company 102) so that the new insurance company can review claims paid by previous insurers. The new insurance company may use the forwarded claims to identify new members who may benefit from case management and similar measures. Continuing the example from above, the computing system 132 may search through the claim database 134, identify claims associated with the patients P1 and P2, and delivers any claims identified to the new insurance company 102. This allows the subsequent insurance company 102 to better manage costs related to known health issues experienced by the patients P1 and P2.

In FIG. 2, the patient P1 was assigned the member identifier “1234” by the previous insurance company 101. The patient P1 is assigned a new member identifier “9922” by the new insurance company 102. For ease of illustration, the previous member identifier assigned by the previous insurance company (e.g., the insurance company 101) will be referred as a previous member identifier (“PM-ID”), and the new member identifier assigned by the new insurance company (e.g., the insurance company 102) will be referred as a new member identifier (“NM-ID”).

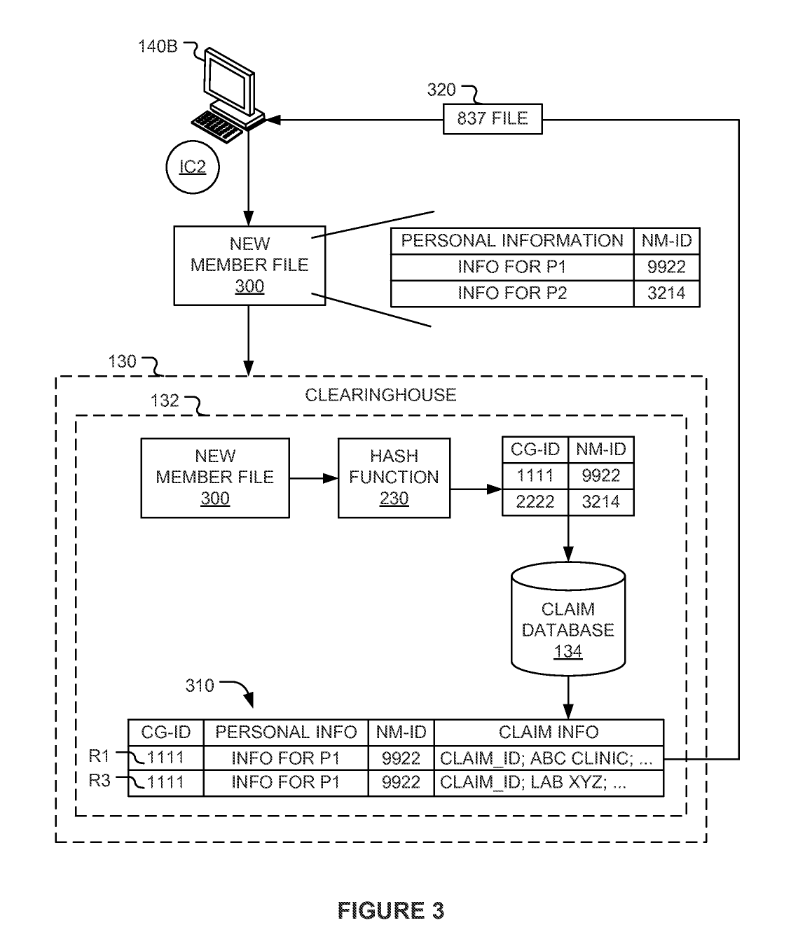

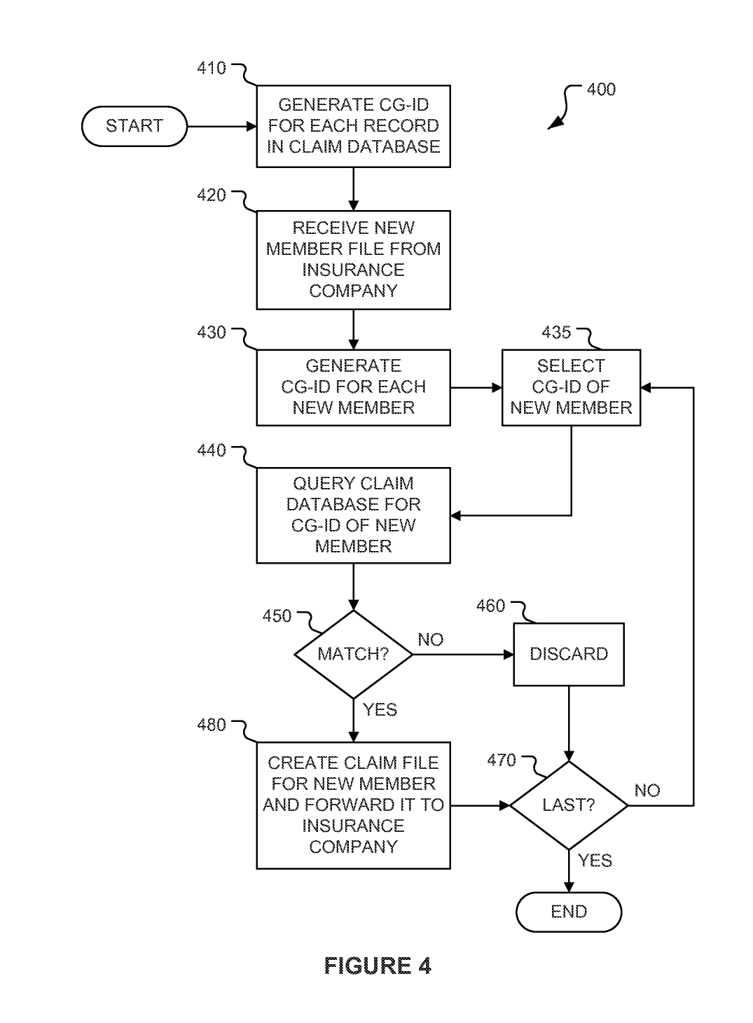

FIG. 4 is a flow diagram of a method 400 performed by the computing system 132 (see FIGS. 1 and 3). FIGS. 2 and 3 illustrate portions of the method 400. Referring to FIG. 4, in first block 410, the computing system 132 (see FIGS. 1 and 3) generates a member identifier for each of the claim records 200 (see FIG. 2) in the claim database 134 (see FIGS. 1-3). Referring to FIG. 2, for ease of illustration, the member identifier generated by the computing system 132 will be referred to as a clearinghouse generated member identifier (“CG-ID”). As is apparent to those of ordinary skill in the art, the CG-ID may be generated and associated with a claim record when the claim record is first stored in the claim database 134. Alternatively, CG-IDs may be generated occasionally (e.g., periodically) for all or a portion of the records 200.

Referring to FIG. 2, a function 230 (e.g., a hash function) is performed on a portion of the personal information 210 stored in each of the claim records 200 to generate a CG-ID for each claim record. In other words, for each of the claim records 200, the CG-ID is generated as a function of personal information related to the patient for whom the claim record was created. Thus, in FIG. 2, a CG-ID (“1111”) is generated for the patient P1, and a CG-ID (“3333”) is generated for the patient P3.

The function 230 may be performed on the patient's (member's) name, the member's date of birth (“DOB”), the member's gender, a portion of the member's address, the state in which the member lives, and the member's zip code. The function is not applied to any member identifiers (e.g., the PM-ID or NM-ID) assigned by the insurance companies 110.

The computing system 132 associates a CG-ID with each of the records 200 in the claim database 134. In other words, the function 230 is applied to all of the claim records 200 stored in the claim database 134. Records created for the same patient will be associated with the same CG-ID. For example, both records R1 and R3 were created for the patient P1 and have been assigned the same CG-ID (“1111”).

Referring to FIG. 4, in block 420, the computing system 132 receives personal information associated with one or more new members from one of the insurance companies 110 (see FIG. 1). For example, referring to FIG. 3, occasionally (e.g., periodically, monthly, and the like), the clearinghouse 130 may receive a new member file 300 from one or more of the insurance companies 110 (e.g., the insurance company 102) that contains personal information associated with one or more new members of the insurance company. In the example illustrated in FIG. 3, the computing device 140B sends the new member file 300 (via the network 160 illustrated in FIG. 1) to the computing system 132 operated by the clearinghouse 300. In this example, the new member file 300 includes personal information identifying two new members, namely, the patients P1 and P2. The new member file 300 also identifies the NM-ID associated with each of the patients P1 and P2. For each new member, the personal information may include the member's name, the member's DOB, the member's gender, the member's address, the state in which the member lives, and the member's zip code.

Returning to FIG. 4, in block 430, the computing system 132 generates a CG-ID for each new member identified in the new member file 300 based on the personal information associated with the new member contained in the new member file 300 (see FIG. 3). For example, referring to FIG. 3, the computing system 132 may apply the function 230 to at least a portion of the personal information associated with each new member in the new member file 300 to create the CG-ID for the new member. As explained above, the function 230 may be performed on the member's name, the member's DOB, the member's gender, a portion of the member's address, the state in which the member lives, and the member's zip code. The function is not applied to the NM-ID associated with each new member in the new member file 300. In the example illustrated, a CG-ID (“1111”) is generated for the patient P1, who is also associated with a NM-ID (“9922”), and a CG-ID (“2222”) is generated for the patient P2, who is associated with a NM-ID (“3214”).

Referring to FIG. 4, in block 435, the computing system 132 selects a CG-ID created for one of the new members. Then, in block 440, the computing system 132 queries the claim database 134 (see FIGS. 1-3) for any of the claim records 200 (see FIG. 2) that are associated with the CG-ID selected in block 435. The query may search for claim records created after a predetermined date. For example, the query may search for claim records created within the past two years.

In decision block 450, the computing system 132 determines whether any records were located by the query performed in block 440. The decision in block 450 is “YES” when the query performed in block 440 located at least one record. On the other hand, the decision in block 450 is “NO” when the query performed in block 440 did not locate any records. For example, the query performed in block 440 would not return any claim record for the CG-ID “2222” associated with the patient P2 because the patient P2 was not previously insured by any of the insurance companies 110. When the decision in decision block 450 is “NO,” in block 460, the computing system 132 discards the CG-ID selected in block 435 (and any information related to the CG-ID), and advances to decision block 470.

In decision block 470, the computing system 132 determines whether all of the CG-IDs generated in block 430 have been selected. The decision in block 470 is “YES” when all of the CG-IDs generated in block 430 have been selected. On the other hand, the decision in block 470 is “NO” when all of the CG-IDs generated in block 430 have not been selected. When the decision in decision block 470 is “YES,” the method 400 terminates. On the other hand, when the decision in decision block 470 is “NO,” the computing system 132 returns to block 435 to select another CG-ID of a new member.

In the example illustrated in FIG. 3, the query performed in block 440 (see FIG. 4) returns claim record(s) 310 for the CG-ID “1111” associated with the patient P1. Thus, the decision in decision block 450 (see FIG. 4) would be “YES” in this example. Referring to FIGS. 3 and 4, when the decision in decision block 450 is “YES,” in block 480, the computing system 132 associates each of the claim record(s) 310 returned by the query performed in block 440 with the NM-ID associated with the CG-ID selected in block 435. Then, the computing system 132 forwards the claim record(s) 310 and the NM-ID to the insurance company 102 from which the new member file 300 was received in block 420. For example, the computing system 132 may print the claim record(s) 310 or at least a portion of the information contained therein, and send (e.g., mail or fax) the printout(s) to the insurance company 102. By way of another non-limiting example, referring to FIG. 3, the computing system 132 may transmit the NM-ID and the claim record(s) 310 or at least a portion of the information contained therein to the computing device 140B operated by the insurance company 102 (e.g., in a claim file 320).

Those of ordinary skill in the art appreciate that standard transactions and code sets have been developed in accordance with electronic data interchange (“EDI”) standards for healthcare. For example, an 837 transaction (or file) is used to submit a claim to an insurance company. An 837 file includes a plurality of segments. For example, an 837 file includes a Transaction Set Header (“ST”) segment followed by a Beginning of Hierarchical Transaction (“BHT”) segment. The following is an exemplary portion of an example 837 file that includes examples of these segments:
ST*837*722315214*005010X222A1˜
BHT*0019*00*722315214*20130703*0909*RP˜
. . .
   In the example above, the ST segment begins with the characters “ST” and ends with the character “˜.” Similarly, the BHT segment begins with the characters “BHT” and ends with the character “˜.” Between the characters “BHT” and the character “˜,” the BHT segment includes information separated by the character “*.” In the example above, this information includes a Hierarchical Structure Code (e.g. “0019”), a Transaction Set Purpose Code (e.g. “00”), a Reference Identification (e.g. “722315214”), a date value (e.g. “20130703”), a time value (e.g. “0909”), and a Transaction Type Code (e.g. “RP”). The Transaction Type Code may store the characters “CH” for a chargeable transaction or the characters “RP” for reporting. Additional information (represented by an ellipsis (“ . . . ”) in the example above) necessary to process the claim or generate reports is included in the 837 file.

In block 480 (see FIG. 4), the computing system 132 may generate the claim file 320 (see FIG. 3; e.g., an 837 transaction or file), which includes the NM-ID associated with the CG-ID selected in block 435 and at least a portion of the claim record(s) 310 returned by the query performed in block 440. Then, the computing system 132 may transmit the claim file 320 to the insurance company 102, or the computing device 140B operated by the insurance company 102. For example, a separate claim file like the claim file 320 may be sent for each of the claim record(s) 310. By way of another non-limiting example, a single claim file like the claim file 320 may be sent for all of the claim record(s) 310.

A parameter value (e.g., the value of the Transaction Type Code) in the claim file 320 may be set to indicate that the claim file 320 is for reporting purposes only, and therefore does not need to be processed for payment. For example, as illustrated in the example above, a field (e.g., the Transaction Type Code) in the BHT segment of the claim file 320 may be set equal to “RP” for reporting.

Returning to FIG. 4, after block 480, the computing system 132 advances to decision block 470 to determine whether all of the CG-IDs generated in block 430 have been selected.

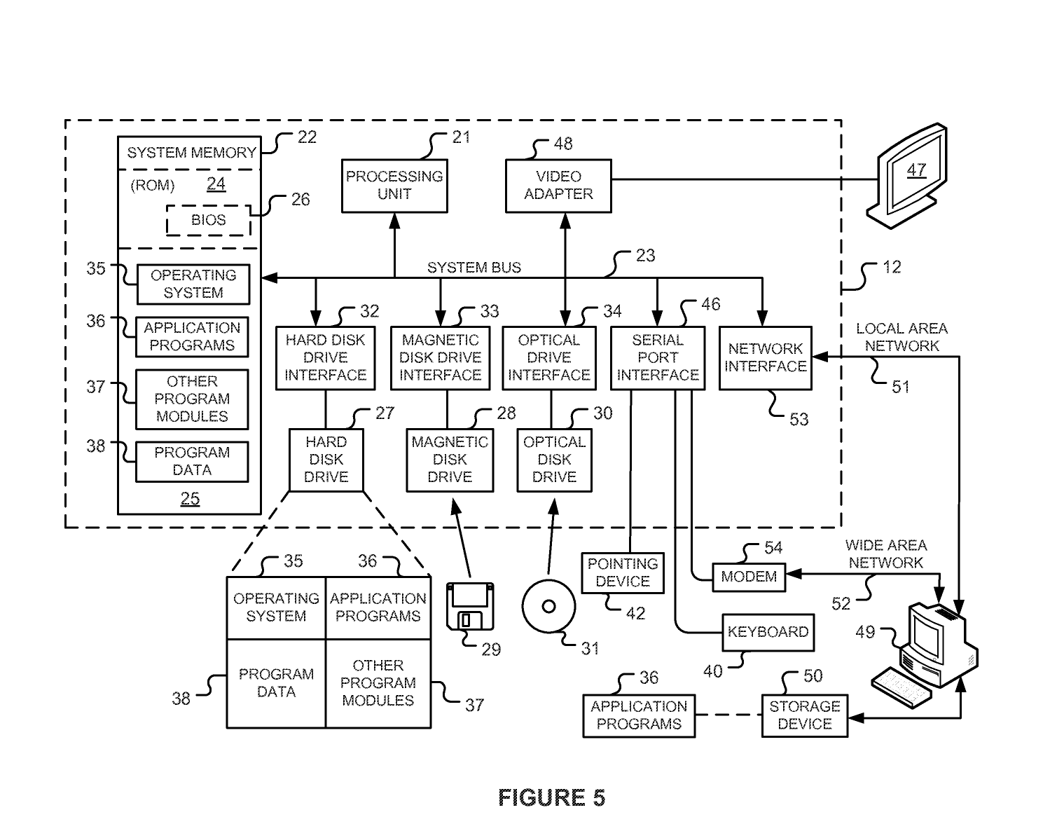

Referring to FIG. 1, each of the computing devices 140A-140E, as well as, the one or more computing devices implementing the computing system 132 may be implemented using a computing device 12 described below and illustrated in FIG. 5.

### Computing Device

FIG. 5 is a diagram of hardware and an operating environment in conjunction with which implementations of the one or more computing devices of the system 100 may be practiced. The description of FIG. 5 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 5 includes a general-purpose computing device in the form of the computing device 12. Each of the computing devices of FIG. 1 (including the computing devices 140A-140E, as well as, the one or more computing devices implementing the computing system 132) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, a processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from and/or writing to a removable magnetic disk 29, and an optical disk drive 30 for reading from and/or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 5 include a local-area network (LAN) 51 and a wide-area network (WAN) 52. Such networking environments are commonplace in offices, enterprise-wide computer networks, intranets and the Internet. The network 160 (see FIG. 1) may be implemented using the LAN 51 and/or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 400 illustrated in FIG. 4) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method comprising:
storing, with a computing system, a plurality of claim records for a plurality of patients insured by a plurality of insurance companies, each claim record storing (a) personal information associated with one of the plurality of patients, and (b) claim information for that patient received from one of a plurality of claim data providers, the claim information stored in at least some of the plurality of claim records having been submitted to different ones of the plurality of insurance companies, the claim information stored in at least some of the plurality of claim records having been received from different ones of the plurality of claim data providers;
automatically generating, with the computing system, a member identifier for each of the plurality of claim records as a function of at least a portion of the personal information stored in the claim record, the claim record being associated with the member identifier generated for the claim record;
obtaining, by the computing system, personal information associated with a particular patient;
automatically generating, with the computing system, a member identifier for the particular patient as a function of at least a portion of the personal information associated with the particular patient;
identifying, with the computing system, one of the plurality of claim records associated with the same member identifier generated for the particular patient; and
forwarding at least a portion of the claim information stored in the identified claim record to a recipient insurance company.

2. The method of claim 1, wherein obtaining the personal information associated with the particular patient comprises:
receiving the personal information associated with the particular patient from the recipient insurance company;

3. The method of claim 2, wherein the personal information associated with the particular patient is received in a new member file transmitted to the computing system over a network by a computing device operated by the recipient insurance company.

4. The method of claim 1, wherein forwarding the portion of the claim information stored in the identified claim record to the recipient insurance company comprises:
printing the portion of the claim information stored in the identified claim record to obtain printed information; and
mailing or faxing the printed information to the recipient insurance company.

5. The method of claim 1, wherein forwarding the portion of the claim information stored in the identified claim record to the recipient insurance company comprises:
transmitting, with the computing system, the portion of the claim information stored in the identified claim record to a computing device operated by the recipient insurance company over a network.

6. The method of claim 1, wherein the claim information is forwarded to the recipient insurance company in an 837 file.

7. The method of claim 6, wherein the 837 file is configured to indicate that the claim information is for reporting purposes only.

8. The method of claim 1, wherein the member identifier is automatically generated for each of the plurality of claim records by performing a hash function on a portion of the personal information stored in the claim record.

9. The method of claim 8, wherein the portion of the personal information stored in the claim record comprises at least one of:
a name of the patient associated with the claim record;
a date of birth of the patient associated with the claim record;
a gender of the patient associated with the claim record;
a portion of an address of the patient associated with the claim record;
a state in which the patient associated with the claim record lives; and
a zip code of the patient associated with the claim record.

10. The method of claim 1, further comprising:
receiving a new member identifier (“NM-ID”) assigned to the particular patient by the recipient insurance company; and
forwarding the NM-ID to the recipient insurance company with the portion of the claim information stored in the identified claim record.

11. The method of claim 1, wherein at least some of the plurality of claim data providers are completely unaffiliated with one another.

12. The method of claim 1, wherein at least some of the plurality of claim data providers are healthcare providers.

13. The method of claim 1, wherein at least one of the plurality of claim data providers is a clearinghouse that does not provide medical or healthcare services.

14. A system comprising:
a data storage storing a plurality of claim records for a plurality of patients insured by a plurality of insurance companies, each claim record storing (a) personal information associated with one of the plurality of patients, and (b) claim information for that one patient received from one of a plurality of claim data providers, the claim information stored in at least some of the plurality of claim records having been submitted to different ones of the plurality of insurance companies, the claim information stored in at least some of the plurality of claim records having been received from different ones of the plurality of claim data providers; and
one or more processors connected to a memory storing instructions that when executed by the one or more processors:
automatically generate a member identifier for each of the plurality of claim records as a function of at least a portion of the personal information stored in the claim record, the claim record being associated with the member identifier generated for the claim record;
obtain personal information associated with a particular patient;
automatically generate a member identifier for the particular patient as a function of at least a portion of the personal information associated with the particular patient;
identify one of the plurality of claim records associated with the same member identifier generated for the particular patient; and
forward at least a portion of the claim information stored in the identified claim record to a recipient insurance company.

15. The system of claim 14, wherein the member identifier is automatically generated for each of the plurality of claim records by performing a hash function on a portion of the personal information stored in the claim record; and
the member identifier is automatically generated for the particular patient by performing a hash function on a portion of the personal information associated with the particular patient.

16. A computer-implemented method comprising:
storing, in a database, a plurality of claim records each associated with a patient, an insurance company, and a claim data provider, each claim record storing (a) personal information associated with the patient associated with the claim record, and (b) claim information for the patient associated with the claim record received from the claim data provider associated with the claim record, different portions of the plurality of claim records being associated with different patients, different portions of the plurality of claim records being associated with different insurance companies, different portions of the plurality of claim records being associated with different claim data providers;
performing, with at least one computing device, a hash function on a portion of the personal information stored in each of the plurality of claim records to generate a plurality of hash values, each associated with one of the plurality of claim records;
performing, with the at least one computing device, the hash function on personal information associated with a plurality of new members to obtain a plurality of member identifiers, each associated with one of the plurality of new members;
identifying, with the at least one computing device, any of the plurality of claim records associated with the hash value that is equal to one of the plurality of member identifiers to obtain one or more identified claim records; and
providing information stored in the one or more identified claim records to a recipient insurance company.

17. The method of claim 16, wherein providing the information stored in the one or more identified claim records to the recipient insurance company comprises:
transmitting, with the at least one computing device, the information stored in the one or more identified claim records to a computing device operated by the recipient insurance company over a network.

18. The method of claim 17, wherein the information stored in the one or more identified claim records is transmitted in at least one 837 file configured to indicate that the information is for reporting purposes only.

19. The method of claim 16, further comprising:
receiving, by the at least one computing device, the personal information associated with the plurality of new members from the recipient insurance company;
receiving, by the at least one computing device, a plurality of new member identifiers, each new member identifier (“NM-ID”) having been assigned to one of the plurality of new members by the recipient insurance company;
associating, with the at least one computing device, each NM-ID with the member identifier obtained for the new member to which the NM-ID was assigned by the recipient insurance company; and
for each of the one or more identified claim records, providing to the recipient insurance company, with the information stored in the identified claim record, the NM-ID associated with the member identifier that is equal to the hash value associated with the identified claim record.
